(19) United States
(12) Patent Application Publication
(10) Pub. No.: US 2010/0300828 A1
(43) Pub. Date: Dec. 2, 2010

(54) Dual-Stage Regulator Valve Assembly

(75) Inventor: Derek Kinch, Ypsilanti, MI (US)

Correspondence Address: Kristy J. Downing, Esq., 39555 Orchard Hill Pl., 6th Fl., PMB No.: 6051, Novi, MI, 48375, US

(73) Assignee: Ford Global Technologies LLC

(21) Appl. No.: 12/476,222

(22) Filed: Jun. 1, 2009

(51) Int. Cl. F16D 25/00

(52) U.S. Cl. 192/85.63

(57) ABSTRACT

The present disclosure relates to dual-stage regulator valve assemblies for use with vehicle transmissions and methods of manufacturing the same. A dual-stage regulator valve is configured to increase a flow area in the valve during clutch fill thereby reducing transmission shift time. Transition between a clutch fill and a pressure control state is automated.

### TECHNICAL FIELD

The present disclosure relates to control valve bodies and regulator valves for a transmission clutch. More specifically, the disclosure teaches several mechanisms for expediting transmission shift time and controllability.

### BACKGROUND

Conventional automatic transmissions include a hydraulic control system that governs transmission operating pressure, fluid flow distribution for cooling, lubrication and other purposes as well as the actuation of various transmission components, e.g., clutch assemblies. Many of these hydraulic control systems include a pressure reducing control valve (or regulator valve) used to regulate hydraulic pressure and fluid distribution to clutches. These regulator valves have two distinct operating conditions. First the regulator valves govern fill and stroke of the clutch. Second the regulator valves regulate the pressure within the clutch to a desired level. The time required for the fill-and-stroke portion directly impacts the overall shift time for the transmission.

These two operating conditions yield requirements from the regulator valves which are often diametrically opposed. High flow is desired to minimize fill-and-stroke of clutch and the overall shift time for the transmission. Fine clutch pressure control is desired for pressure regulation during ratio change. The transition between these two states is also a factor in managing shift quality.

Therefore it is desirable to have a control system that optimally manages the two operating conditions for regulator valves. It is likewise desirable to have a system that minimizes the time required for the fill-and-stroke portion of regulator valve operation.

### SUMMARY

The present invention may address one or more of the above-mentioned issues. Other features and/or advantages may become apparent from the description which follows.

Certain embodiments of the present invention provide a hydraulic control circuit for controlling a transmission clutch, having: a control valve body configured to be in fluid communication with the transmission clutch; a regulator valve in the control valve body configured to direct fluid to the transmission clutch, the regulator valve including a dual-stage plunger assembly. A flow area in the regulator valve is greater when the dual-stage plunger assembly is operating in a second stage than when operating in a first stage.

Another embodiment of the present invention provides a control valve body for controlling a transmission clutch, including: a spool valve configured to move within a bore in the body; and a dual-stage plunger assembly at one end of the bore. The plunger assembly includes: a plunger; a first spring between the spool valve and plunger; and a second spring between the plunger and the control valve body. When the assembly is in a first stage the plunger is in a first position and when the assembly is in a second stage the second spring compresses and the plunger moves into a second position. A flow area across the spool valve is greater when the plunger is in the second position. The dual-stage plunger assembly is configured to automatically transition between the first stage and the second stage when the transmission clutch approaches an end of fill. Also included in the control valve body is a flow control orifice in the control valve body at the bore; a first channel extending between the flow control orifice and the clutch; and a second channel extending between the dual stage plunger assembly and the first channel. The second channel is configured to decrease pressure at one end of the plunger assembly during clutch fill thereby enabling the plunger assembly to operate in the second stage.

According to one exemplary embodiment a control valve body for controlling a transmission clutch, includes: a regulator valve configured to direct the fluid to the transmission clutch; and a control pressure circuit in fluid communication with the regulator valve. The control pressure circuit includes: a latch valve; and a channel extending between the regulator valve and the latch valve. The regulator valve has a first stage and second stage of operation and the flow area in the regulator valve is greater when the regulator valve is operating in the second stage than when operating in the first stage. The control pressure circuit is configured to decrease pressure at one end of the regulator valve during clutch fill thereby enabling the assembly to operate in the second stage. The regulator valve is configured to automatically transition between the first stage and the second stage when the transmission clutch approaches an end of fill.

According to another exemplary embodiment a method of manufacturing a hydraulic control valve body for controlling a transmission clutch is provided. The method includes: configuring a control valve body to be in fluid communication with the transmission clutch; providing a regulator valve in the control valve body configured to direct fluid to the transmission clutch; and configuring the regulator valve to operate in two stages. A flow area in the regulator valve is greater when the regulator valve is operating in a second stage than when operating in a first stage.

One of the advantages of the present teachings is that they provide solutions for optimizing the two operating conditions of a regulator valve assembly thereby improving the overall shift time and quality for a vehicle transmission.

Another advantage of the present teachings is a dual-stage regulator valve assembly that enables an increased flow area during clutch fill and automatically returns to a reduced flow area during other regulating conditions.

Another advantage of the disclosed regulator valve assemblies is that they remove the possibility of oscillation due to transition across the flow gain feature to full annulus during pressure increase commands for stroked clutch control, as well as reduce the sensitivity to input noise or dither frequencies.

Yet another advantage of the present teachings is that they remove the requirement for calibration of high pressure command for clutch stroke “boost.” This also reduces the probability of poor shift quality due to “overboost” which is commonly caused by human or mechanical errors during calibration.

An additional advantage of an exemplary regulator valve and latch valve disclosed herein is the elimination of a need to exhaust highly restricted feedback control pressure at the regulator valve. Thus the control valve body has better control of and faster return to clutch control mode.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same references numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is an illustration of a control valve body according to an exemplary embodiment of the present invention.

FIG. 2 is a side view of a regulator valve assembly, according to another exemplary embodiment of the present invention, in a pressure regulating position.

FIG. 3 is a side view of the regulator valve of FIG. 2 in a clutch stroking position.

FIG. 4 is a side view of a regulator valve assembly according to another exemplary embodiment of the present invention.

FIG. 5 is an illustration of a control valve body according to another exemplary embodiment of the present invention.

FIG. 6 is a side view of a regulator valve assembly, according to another exemplary embodiment of the present invention, in a pressure regulating position.

FIG. 7 is a side view of the regulator valve of FIG. 6 in a clutch stroking position.

FIG. 8 is a side view of a regulator valve assembly according to another exemplary embodiment of the present invention.

FIG. 9 shows projected performance diagrams of a regulator valve assembly according to an exemplary embodiment of the present invention.

FIG. 10 is a flowchart of a method of manufacturing a hydraulic control valve body for controlling a transmission clutch.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION

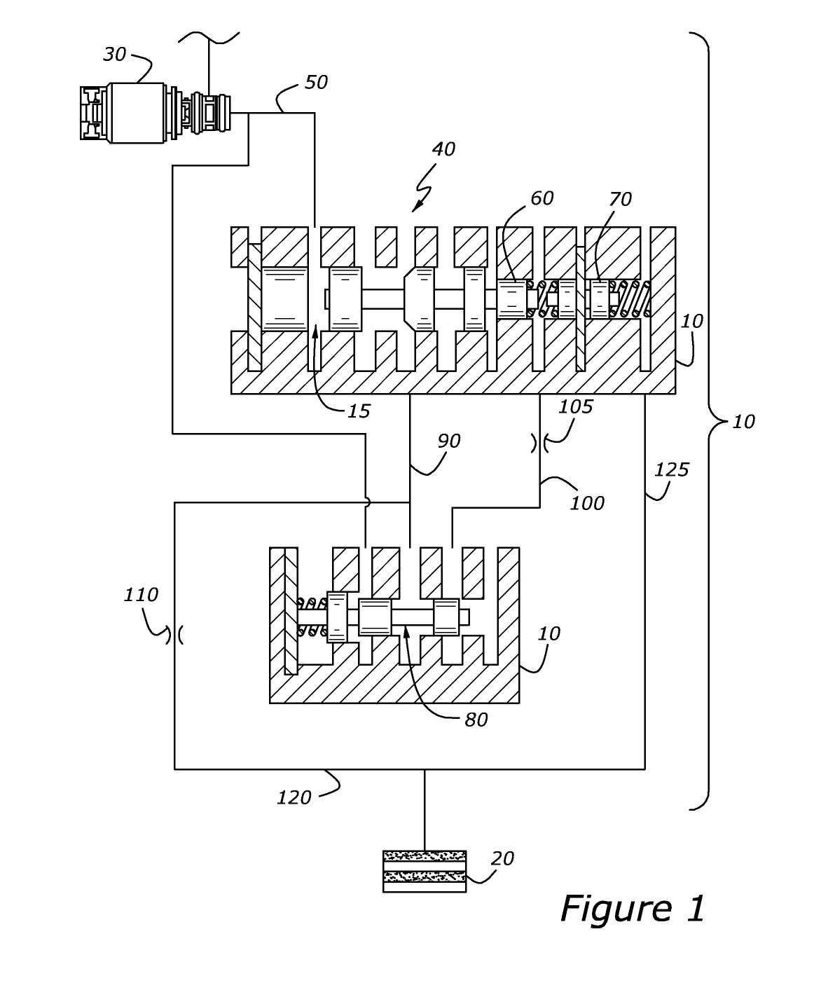

Referring to the drawings, FIGS. 1-10, wherein like characters represent the same or corresponding parts throughout the several views there is shown control valve bodies that minimize the time required for the fill-and-stroke portion of regulator valve operation. The control valve bodies also demonstrate improved controllability between the clutch stroke and pressure regulating modes of operation.

Referring now to FIG. 1, there is shown therein a schematic depiction of a hydraulic control valve body 10 or control circuit for controlling a transmission clutch 20. The control valve body 10 is in fluid communication with a hydraulically actuable clutch assembly 20. The control valve body 10 governs clutch application. An electro-hydraulic solenoid 30 in the control body 10 selectively provides pressure signals to a regulator valve assembly 40 (or regulator valve); the regulator valve 40 in turn supplies fluid to the clutch assembly 20. The regulator valve 40 is configured to receive fluid therein. In the shown embodiment, the regulator valve 40 is in direct fluid communication with the solenoid 30 through channel 50. Once solenoid 30 sends a predetermined pressure to the regulator valve 40, the regulator valve directs a proportional pressure to the transmission clutch assembly 20.

The regulator valve 40, shown in FIG. 1, is an exemplary dual-stage regulator valve assembly. The regulator valve 40 operates in at least two stages. A spool valve 60 is movable with respect to the regulator valve assembly 40. The spool valve 60 is attached to a movable anchor or base, e.g., plunger assembly 70—or second spool valve—as shown in FIG. 1. When the plunger assembly 70 is in a first position the regulator valve assembly 40 has a greater flow area than when the regulator valve is in a second position. Plunger assembly 70 operates in a first stage when the plunger assembly 70 is in the first position and a second stage when the plunger assembly 70 operates in a second stage. During the second stage, regulator valve 40 is configured to receive fluid and fill the clutch assembly 20. The plunger assembly 70 moves along a longitudinal axis of the regulator valve assembly 40. As the plunger assembly 70 moves rightward, the spool valve 60 opens the regulator valve assembly 40 up and the flow area in the regulator valve assembly increases. The plunger assembly 70 is configured to automatically transition between the first stage and second stage when the transmission clutch 20 approaches the end of a fill cycle. Accordingly, the flow capabilities of the regulator valve assembly 40 are increased and the overall shift time for the clutch assembly 20 is reduced.

In the illustrated embodiment of FIG. 1, a latch valve assembly 80 or latch valve is in fluid communication with the regulator valve 40 through channels 90 and 100. Latch valve 80, as shown in the latched position, exhausts a downstream fluid from one portion of the regulator valve 40 to another portion. The latch valve 80 is configured to receive control port fluid, upstream of a flow control orifice 110 through channel 90, from the regulator valve 40. The latch valve 80 is configured to reduce the pressure at one end of the regulator assembly fed through feedback channel 100, when sufficient pressure from solenoid 30 is attained, thus resulting in the applied clutch 20 being pressurized at full supply pressure (latched). A flow control orifice 105 is also in channel 100.

The regulator valve, as shown in FIG. 1, also includes a dual-stage plunger assembly 70. Pressure in channel 120 is downstream of flow control orifice 110 and is in communication with clutch 20 and plunger assembly 70 through channel 125. The regulator valve assembly 40 spring biases the spool valve 60 within a bore 15 of the control valve body 10—enabling selective fluid distribution per solenoid 30 pressure at regulator valve 40; the plunger assembly 70 is also biased with respect to the control valve body 10—thereby enabling the plunger 70 to move and change reference frame of regulator valve assembly 40 increasing the fluid flow area in the regulator valve assembly 40.

Discussed herein below are various exemplary two-stage regulator valve assemblies that reduce the fill time for a transmission clutch assembly and automates the transition between high flow and pressure regulation states. Though the regulator valves are discussed in two stages the regulator valves can be configured to operate in more than two stages.

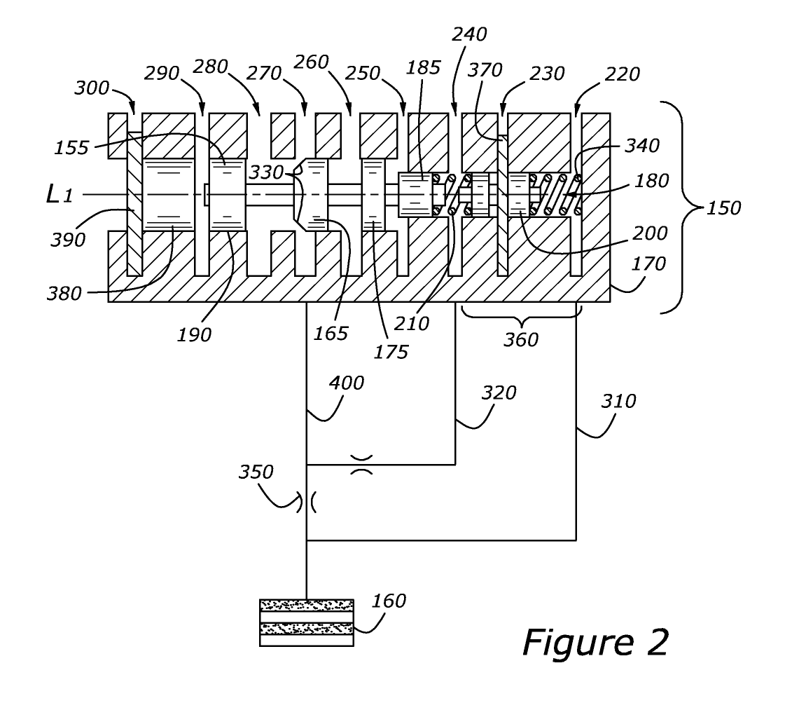

Referring now to FIG. 2, there is shown therein an exemplary dual-stage regulator valve assembly 150. The regulator valve assembly 150 is shown in a first stage or position. In this stage the signal pressure required to move a spool valve 190 to an open or first position is achieved. The clutch assembly 160 is stroked (or applied), stroking at minimal flow rate. The regulator valve assembly 150 is included in a control valve body 170. A bore 180 is formed in the control valve body 170. The spool valve 190 is nested in a control valve bore 180 in the control body 170. Spool valve 190 is biased (or sprung) with respect to a plunger 200, which is shown in a first (or home) position in FIG. 2. A coil spring 210 is positioned between the plunger 200 and the spool valve 190. Spool valve 190 is configured to move along a longitudinal axis L₁. Spool valve 190 has a variable diameter along the longitudinal axis L₁ of spool valve. The area differential of the spool valve 190 and lands 155, 165, 175 and 185, act in concert with ports (e.g., 220-290) in control body 170 to govern the distribution of fluid through control body. In the shown embodiment, ports 220, 230, 240, 250, 260, 270, 280, 290 and 300 are a series of annular grooves in fluid communication with other portions of the control body 170 and/or the transmission clutch assembly 160.

The spool valve 190 shown in FIG. 2, can achieve various positions to regulate flow distribution to the clutch assembly 160. Port 290 is in fluid communication with an electro-hydraulic solenoid that selectively provides a pressure force to the regulator valve assembly 150. Ports 220, 240 and 270 are in fluid communication with the transmission clutch assembly 160 and port 270 provides fluid to the clutch assembly. In the illustrated embodiment of FIG. 2, spool valve 190 is shown in a first or regulating position. In the regulating position, regulator valve assembly 150 is at least partially open allowing fluid communication from port 270 to port 280 through control valve bore 180. Ports 250 and 260 are exhausts and are open to sump. Port 240 provides a feedback pressure to the regulator valve via channel 320. The actual pressure provided to the clutch assembly 160 is in communication with regulator valve assembly via channel 310. Spool valve 190 may include a flow gain control feature such as chamfered edge 330 or ramp. Chamfered edge 330 provides reduced flow area when opening regulator valve 150 into port 270, verses full annulus. Flow gain control feature could instead be incorporated into port 270. Port 290 is sealed from the exterior using bore plug 380. Spool valve 190 and bore plug 380 are retained in bore 180 by retaining plate 390.

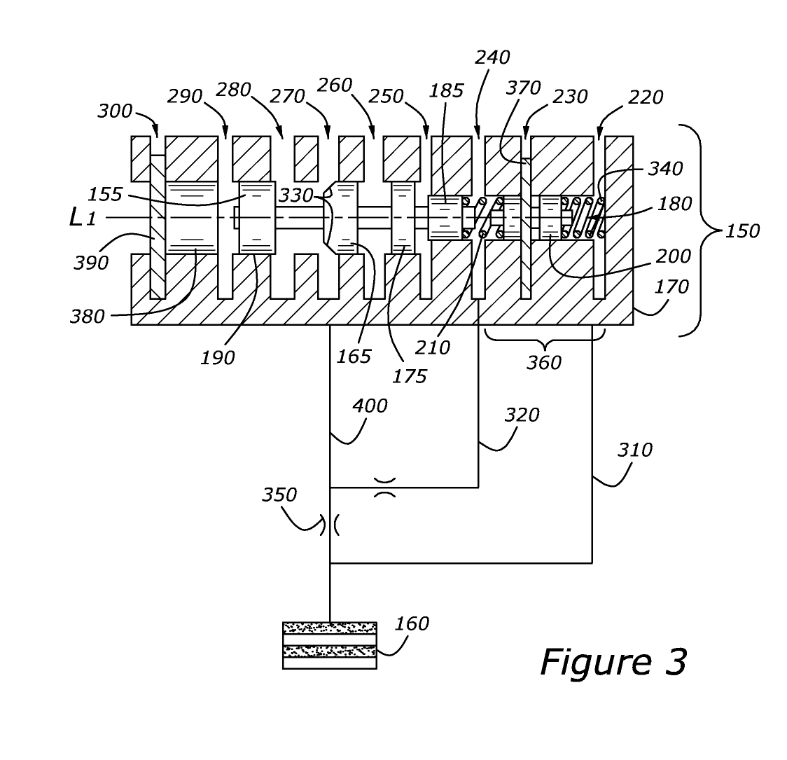

A dual-stage plunger assembly 360 is also shown in FIGS. 2 and 3. The plunger assembly 360 includes the plunger 200 that is biased with respect to the control valve body 170. In FIG. 2, the plunger 200 is shown in a first or home position. The plunger 200 is positioned between springs 210 and 340 within bore 180. A retainer plate 370 in port 230 straddles the plunger 200 and limits its travel in both directions along longitudinal axis L₁. In the shown embodiment, spring 340 is at sufficiently higher load than spring 210 so that the plunger 200 is biased rightward when pressure difference between sides of plunger 200 is below a designed value. During the second stage of operation, spring 340 also compresses enabling the plunger 200 to move and the regulator valve 150 to increase the flow area therein. The plunger 200 is configured to automatically transition between the first stage and second stage when the transmission clutch 160 approaches the end of a fill cycle.

The regulator valve assembly 150 includes a flow control orifice 350. The flow control orifice 350 is in control circuit 400 between feedback channel 320 and channel 310 which feeds clutch assembly 160 and port 220. In this arrangement, channel 310 is configured to provide decreased pressure at one end of the plunger assembly (e.g., chamber 220) during clutch fill. The pressure drop across flow control orifice 350 while providing flow to stroke clutch assembly 160 provides the aforementioned decreased pressure. For first stage, the pressure differential across plunger 200 is below which is required to overcome spring 340. Regulator valve assembly 150 is biased leftward with the assembly's total travel limited by bore plug 380 and plunger or spool valve 200.

Flow gain notches 330 on spool valve 190, or similar features built into port 270 are devised to provide a flow area less than that of full annulus. This configuration is determined by stability and response requirements for stroked clutch control. The length of the flow gain feature along axis L₁ is set to be such that it governs flow area up to a maximum rightward travel of spool valve 190 position in a first stage the regulator valve assembly 150. Spool valve 190 then responds to pressure changes from solenoid into port 290 by opening communication area from port 280 to port 270.

Referring now to FIG. 3, there is shown therein the regulator valve assembly 150 of FIG. 2 in a second stage. A signal pressure is received by the regulator valve assembly 150; the clutch assembly 160 is filling and stroking. Spring 210 is compressed as per force imparted by solenoid signal pressure and its spring rate. Due to force imbalance resulting from pressure differential caused by flow control orifice 350 spring 340 has compressed until plunger 200 is stopped by retaining plate 370. Spool valve assembly 190 is moved farther rightward as well, allowing for full annular flow from port 280 to port 270. The increased flow area in second stage allows for greater flow area for a given solenoid command pressure than is possible in first stage resulting in faster clutch stroke. The flow capability of the regulator valve assembly 150 is increased, not only by the movement of the spool valve 190 with respect to the plunger 200 but also by the movement of the dual-stage plunger assembly 360 with respect to the control valve body 170.

As clutch assembly 160 approaches a predetermined pressure the differential on plunger 200 will decrease to a point at which plunger 200 will move leftward back to the first stage position. Transition back to a first stage position will return spool valve 190 to pressure control configuration, where it will meter flow from port 280 to port 270 based on force balance on spool valve 190. The automated return to pressure control configuration eliminates the requirement for additional calibration command.

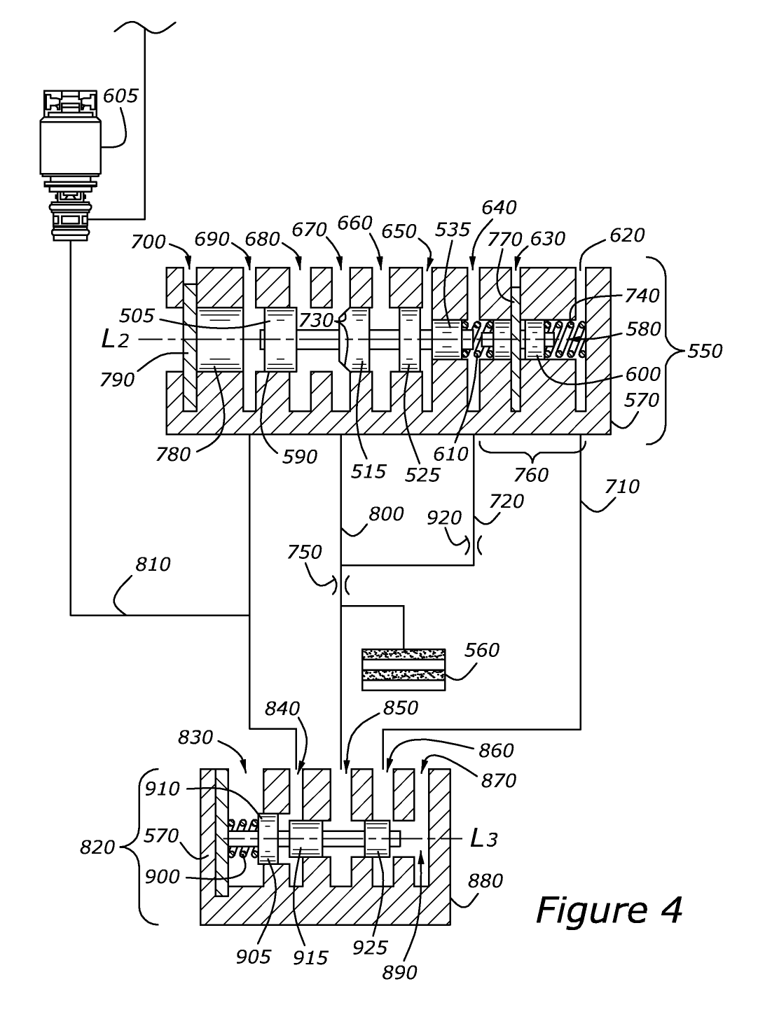

FIG. 4 illustrates another exemplary embodiment of a dual-stage regulator valve assembly or regulator valve 550. Regulator valve 550 is connected to a latch valve assembly 820 that receives fluid downstream of flow control orifice 750 and supplies this to regulator valve assembly 550 at port 620 when operating in a first stage. In this arrangement, in addition to when sensing flow across flow control orifice 750, the second stage of regulator valve assembly 550 can be achieved through exhausting channel 710 and port 620 through control of latch valve 820 by electro-hydraulic solenoid command.

Referring now to FIG. 4, there is shown therein an exemplary dual-stage regulator valve assembly 550. The regulator valve assembly 550 is shown in a second stage. In this stage the signal pressure required to move the spool valve 590 to an open position is achieved. The clutch assembly 560 is stroked (or applied). The regulator valve assembly 550 is included in a control valve body 570. A bore 580 is formed in the control valve body 570. The spool valve 590 is nested in a control valve bore 580 (or pressure chamber) in the control body 570. Spool valve 590 is biased (or sprung) with respect to a plunger assembly 600 or spool valve, which is shown in a second position in FIG. 4. A coil spring 610 is positioned between the plunger 600 and the spool valve 590. Spool valve 590 is configured to move along a longitudinal axis L₂. Spool valve 190 has a variable diameter along the longitudinal axis L₂. The area differential of the spool valve 590 and lands 505, 515, 525 and 535 act in concert with ports (e.g., 620-690) in control body to govern the distribution of fluid through control body 570. In the shown embodiment, ports 620, 630, 640, 650, 660, 670, 680, 690 and 700 are a series of annular grooves in fluid communication with other portions of the control body 570 and/or the transmission clutch assembly 560.

The spool valve 590 of FIG. 4, can achieve various positions to regulate flow distribution to the clutch assembly 560. Port 690 is in fluid communication with an electro-hydraulic solenoid that selectively provides a pressure force to the regulator valve assembly 550. Ports 620, 640 and 670 are in fluid communication with the transmission clutch assembly 560 and port 670 provides fluid to the clutch assembly. In the illustrated embodiment of FIG. 4, spool valve 590 is shown in the regulating position. In the regulating position regulator valve assembly 550 is at least partially open allowing fluid communication from port 670 to port 680 through control valve bore 580. Ports 650 and 660 are exhausts and are open to sump. Port 640 provides a feedback pressure to the regulator valve via channel 720. The actual pressure provided to the clutch assembly 560 is in communication with regulator valve assembly 550 via channel 710. Spool valve 590 may include a flow gain control feature such as chamfered edge 730 or ramp. Chamfered edge 730 provides reduced flow area when opening regulator valve 550 into port 670, verses full annulus. Port 690 is sealed from the exterior using bore plug 780. Spool valve 590 and bore plug 780 are retained in bore 580 by retaining plate 790.

A dual-stage plunger assembly 760 is also shown in FIGS. 4. The plunger assembly 760 includes the plunger 600 that is biased with respect to the control valve body 570. In FIG. 4, the plunger 600 is shown in a second position. The plunger 600 is positioned between springs 610 and 740 within bore 580. A retainer plate 770 in port 630 straddles the plunger 600 and limits its travel in both directions along longitudinal axis L₂. In the shown embodiment, spring 740 is at sufficiently higher load than spring 610 so that the plunger 600 is biased leftward when the pressure difference between sides of plunger 600 is below a designed value.

With respect to FIG. 4, downstream fluid is channeled to the latch assembly 820 from chamber 670 through channel 800. The latch valve 820 is also in fluid communication with the regulator valve assembly 550 through channels 710 and 810. Latch valve 820 exhausts a downstream fluid from one portion of the regulator valve 550 to another portion. Channel 810 is in direct fluid communication with port 840 which receives the signal pressure from an electro-hydraulic solenoid 605. Channel 800 is connected to another channel 720 that extends between the latch valve assembly 820 and regulator valve 550 at port 640. When signal pressure from solenoid 605 is received in the regulator valve 550, this pressure is also experienced in the latch valve 820. Latch valve assembly 820 is included in a remote location on the control valve body 570. Latch valve assembly 820 includes a spool valve 910 in bore 890. The spool valve 910 is configured to move along a longitudinal axis L₃. A spring 900 is included in the latch valve assembly 820. Spool valve 910 is biased with respect to a wall of the control valve body 570 by spring 900.

Spool valve 910 has a variable diameter along the longitudinal axis L₃ of spool valve. The area differential of the spool valve 910 and lands 905, 915, and 925 act in concert with ports (e.g., 840-860) in control body 570 to govern the distribution of fluid to port 620. The spool valve 910 of FIG. 4 can achieve various positions to regulate flow distribution to the port 620. Latch valve 820 is configured to step quickly from installed position to the position shown in FIG. 4, where spring 900 is compressed, as electro-hydraulic solenoid 605 steps above designated pressure. In the aforementioned “stroked” position, port 860 is in communication with port 870 and is thus exhausted.

In FIG. 1, Increasing solenoid pressure beyond designated pressure can result in breaking communication between supply and output circuits of latch valve assembly 820 (e.g., at ports 850 and 860 respectively shown in FIG. 4). In this embodiment, the flow would provide a feedback pressure to regulator valve 550 at port 640. When spool valve 910 is in a “stroked” position, the feedback pressure will be removed from regulator valve 550, creating a force imbalance, resulting in regulator valve 550 shifting rightward and compressing spring 610 into a “stroked” position. In “stroked” position regulator valve 550 allows full communication between ports 670 and 680, which increase clutch pressure to equal to a supply pressure. This configuration is used to maintain clutch 560 pressure at supply levels beyond a proportional range of electro-hydraulic solenoid.

Considering now the embodiment shown in FIG. 4, latch valve assembly 820 is configured to break communication between supply and output circuits of latch valve, at ports 850 and 860 respectively where that circuit contains the pressure downstream of flow control orifice as described above for FIGS. 2 and 3. When spool valve 910 is in the “stroked” position, channel 800—which is fed into port 850—will be disconnected from port 860 and channel 710. Channel 710 is no longer in fluid communication with port 620 and plunger 600. The pressure differential seen across plunger 600 causes plunger to move rightward until restrained by retaining plate 770 resulting in the second stage configuration as described above. When sensing flow across flow control orifice 750, the second stage of regulator valve assembly 550 can be achieved through exhausting channel 710 and port 620 through control of latch valve 820 by electro-hydraulic solenoid command.

The embodiment shown in FIG. 4 provides a means to maintain clutch pressure at supply levels, beyond a range proportional to that of the electro-hydraulic solenoid 605, without altering force balance on spool 590 or exhausting feedback pressure at port 640. Exhausting feedback pressure can result in the accumulation of air in channel 720 downstream of control orifice 920. The feedback circuit effectiveness in controlling valve stability can be sensitive to circuit compliance, which air introduction will also affect. The dual-stage regulator valve assembly configuration will allow for faster return to clutch control mode where regulator valve 550 flows between port 680 and 670 as control orifice 920 is generally more restrictive than flow control orifice 750.

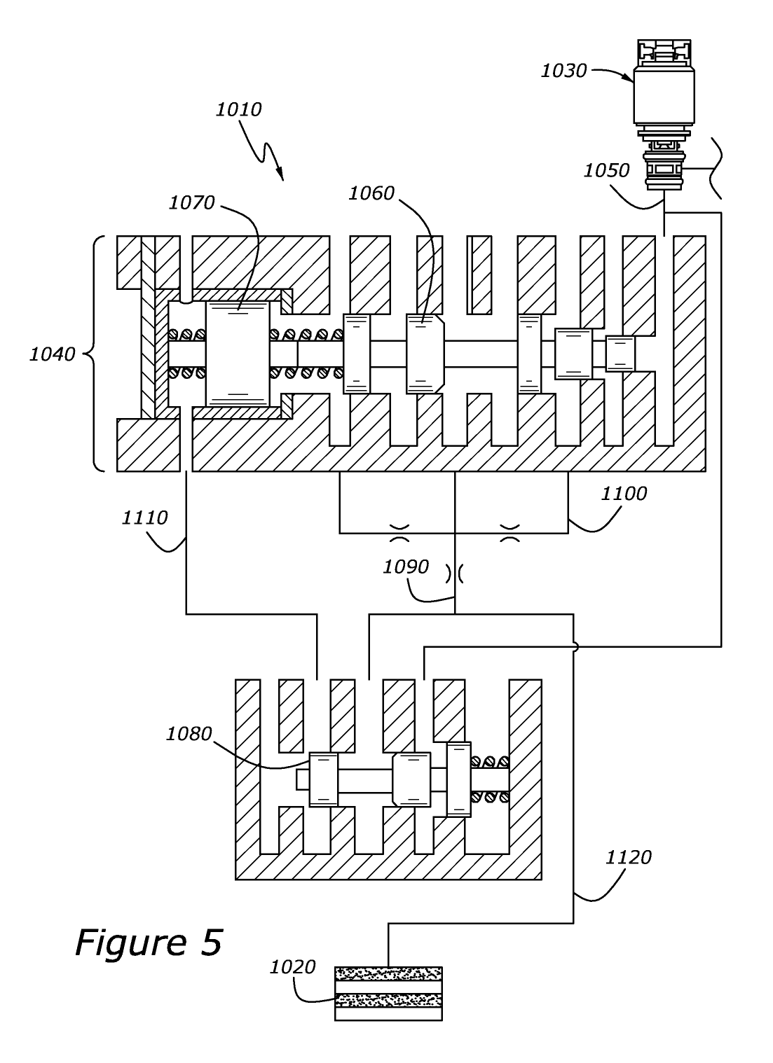

Referring now to FIG. 5, there is shown therein a schematic depiction of a hydraulic control valve body 1010 or control circuit for controlling a transmission clutch 1020. The control valve body 1010 is in fluid communication with a hydraulically actuable clutch assembly 1020. The control valve body 1010 governs clutch application. An electro-hydraulic solenoid 1030 selectively provides pressure signals to a regulator valve 1040, the regulator valve in turn supplies fluid to the clutch assembly 1020. The regulator valve assembly 1040 is configured to receive fluid therein. In the shown embodiment, the regulator valve 1040 is in direct fluid communication with the solenoid 1030 through channel 1050. Once solenoid 1030 sends a predetermined amount of fluid to the regulator valve 1040, a signal pressure is achieved at the regulator valve assembly 1040 and the regulator valve exhausts fluid to the transmission clutch assembly 1020.

The regulator valve 1040, shown in FIG. 5, is an exemplary dual-stage regulator valve assembly. The regulator valve 1040 operates in at least two stages. A spool valve 1060 is movable with respect to the regulator valve assembly 1040. The spool valve 1060 is attached to a movable anchor or base, e.g., plunger 1070 as shown in FIG. 5. When the anchor 1070 is in a first position the regulator valve assembly 1040 has a smaller flow area than when the regulator valve is operating in a second stage. During the second stage, regulator valve 1040 is configured to receive fluid and fill the clutch assembly 1020. The anchor 1070 moves along a longitudinal axis of the regulator valve assembly 1040. As the anchor 1070 moves, the spool valve 1060 opens the regulator valve 1040 up and the flow area in the regulator valve assembly increases. Accordingly, the flow capabilities of the regulator valve assembly 1040 are increased and the overall shift time for the clutch assembly 1020 is reduced.

In the illustrated embodiment of FIG. 5, the regulator valve assembly 1040 has two enablers of the second stage of operation. A latch valve 1080 is in fluid communication with the regulator valve 1040 through channels 1090, 1100 and 1110. The latch valve 1080 is configured to receive a downstream of fluid, through channel 1090, from the regulator valve 1040 to reduce the pressure at one end of the regulator assembly and enable the second stage of operation at a predetermined solenoid pressure. The plunger assembly 1070 is configured to automatically transition between the first stage and second stage when the transmission clutch 1020 approaches the end of a fill cycle. The latch valve 1080 is also configured to supply downstream fluid, through channels 1110 and 1120, to clutch 1020.

The regulator valve, as shown in FIG. 5, also includes a dual-stage plunger assembly 1070. The plunger assembly 1070 spring biases the spool valve 1060 within a bore of the control valve body 1010—enabling selective fluid distribution per pressure in the valve 1040; the plunger assembly 1070 is also biased with respect to the control valve body 1010—thereby enabling the plunger 1070 to move and increase the fluid flow area in the regulator valve assembly 1040.

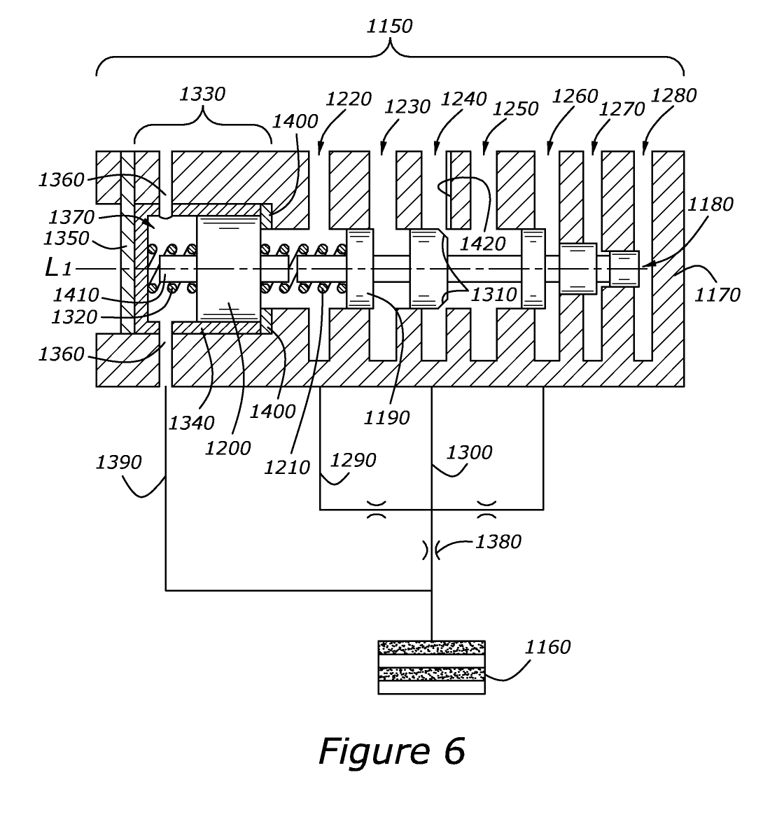

Referring now to FIG. 6, there is shown therein an exemplary dual-stage regulator valve assembly 1150. The regulator valve assembly 1150 is shown in a first stage. In this stage the signal pressure required to move the spool valve 1190 to an open position is achieved, the clutch 1160 is applied. The regulator valve 1150 is included in a control valve body 1170. A bore 1180 is formed in the control valve body 1170. A spool valve 1190 is nested in a control valve bore 1180 (or pressure chamber) in the control body 1170. Spool valve 1190 is biased (or sprung) with respect to a plunger 1200, which is shown in a first (or home) position in FIG. 6. A coil spring 1210 is positioned between the plunger 1200 and the spool valve 1190. Spool valve 1190 is configured to move along a longitudinal axis L₁. Spool valve 1190 has a variable diameter along the longitudinal axis L₁ of spool valve. The portions of the spool valve 1190 having a smaller diameter act in concert with ports or vents (e.g., 1220-1280) in control body to govern the distribution of fluid through control body 1170. In the shown embodiment, ports 1220, 1230, 1240, 1250, 1260, 1270 and 1280 are a series of annular grooves in fluid communication with other portions of the control body 1170 and/or the transmission clutch assembly 1160.

The spool valve 1190 of FIG. 6, can achieve various positions to regulate flow distribution to the clutch assembly 1160. Port 1280 is in fluid communication with an electro-hydraulic solenoid that selectively provides a pressure increase to the regulator valve assembly 1150. Port 1220, 1240 and 1260 are in fluid communication with the transmission clutch assembly 1160 and provide fluid to the clutch assembly. In the illustrated embodiment of FIG. 6, spool valve 1190 is shown in a first, regulating position. In this position, regulator valve assembly 1150 is at least partially open allowing fluid communication from port 1240 to 1250 through control bore 1180. Ports 1230 and 1270 are exhausts and open to sump. In the first position ports 1220, 1230, 1250 and 1280 are at least partially open and allow fluid to enter/exit the control valve bore 1180. Ports 1240, 1260 and 1270 are closed. Ports 1220 and 1260 provide a feedback pressure to the regulator valve. The actual pressure provided to the clutch assembly 1160 is balanced against the signal pressure via channels 1290 and 1300. Spool valve 1190 includes a chamfered edge 1310 or ramp. Chamfered edge 1310 provides reduced flow area when opening regulator valve 1150 into port 1250, versus operating at full annulus. Flow gain control feature, notch 1420 could instead be incorporated into port 1240.

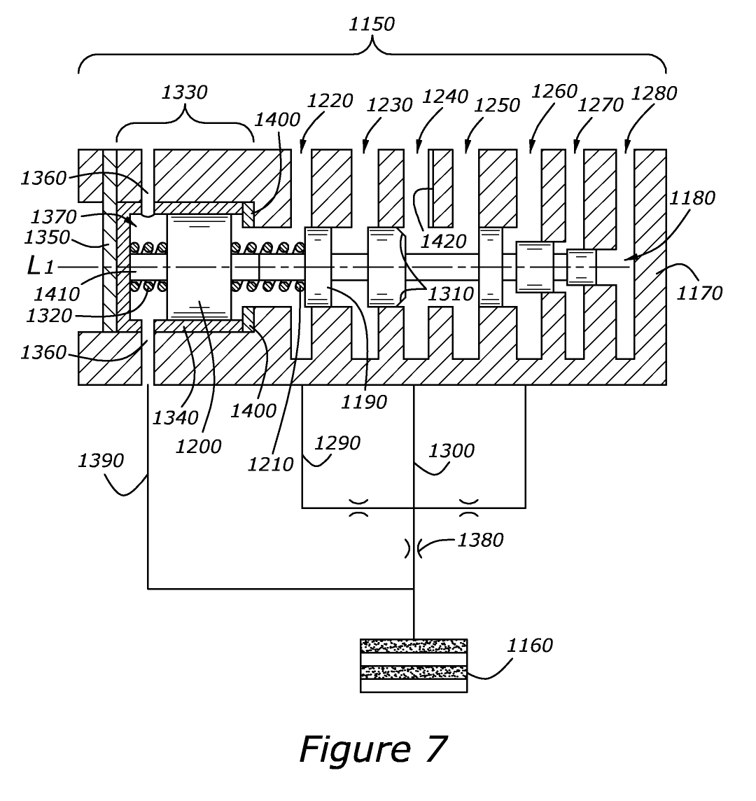

A dual-stage plunger assembly 1330 is also shown in FIGS. 6-7. The plunger assembly 1330 includes the plunger 1200 that is biased with respect to the control valve body 1170. In FIG. 6, for example, the plunger 1200 is shown in a first or home stage. Plunger assembly 1330 is nested in a bore sleeve 1340. The sleeve 1340 is positioned between spring 1320 and a retainer plate 1350 in the control valve body 1170. In the shown embodiment, the bore sleeve 1340 includes an orifice 1360 through which fluid can enter/exit chamber 1370. Spring 1320 enables plunger 1200 to move along longitudinal axis L₁. In the shown embodiment, spring 1320 is at sufficiently higher load than spring 1210 so that the plunger 1200 is biased rightward when the pressure difference between sides of plunger 1200 is below a predetermined value. Spring 1210 compresses until spool valve 1190 moves leftward. During the second stage, spring 1320 also compresses enabling the plunger 1200 to move and the regulator valve 1150 to increase the flow area therein.

The regulator valve assembly 1150 includes a flow control orifice 1380. The flow control orifice 1380 is in fluid communication with the clutch assembly 1160 through channel 1300. A downstream fluid is also provided to the clutch assembly 1160 from chamber 1240 through channels 1300 and 1380. In this arrangement, the downstream fluid travels through channel 1300 which extends from the flow control orifice 1380 to the clutch assembly 1160. Channels 1390 and 1300 are connected and supply fluid to the clutch assembly 1160. Channel 1390 provides fluid to transmission clutch 1160 as channel 1390 is configured to decrease the pressure at one end of the plunger assembly (e.g., chamber 1370) during clutch fill. Channel 1390 enables the plunger assembly 1330 to move to the second position and operating in the second stage. When the regulator valve 1150 experiences a pressure in excess of a predetermined amount fluid is directed from chamber 1370 toward the clutch assembly 1160. For example, when the pressure in the regulator valve 1150 approaches the signal pressure the spring 1320 compresses and fluid exhausts from chamber 1370. Under these circumstances, the regulator assembly 1150 is in the second stage and the plunger assembly 1330 moves toward the bore sleeve 1340. As fluid exits chamber 1370 the fluid further assists in filling the clutch assembly 1160 and reducing shift time. In this manner, the plunger assembly 1330 also provides a downstream pressure to the clutch assembly 1160.

In the illustrated embodiment of FIG. 6, the regulator valve assembly 1150 includes a mechanical stop 1400 in the bore. Stop 1400 includes a flange that is incorporated into the control valve body 1170. Stop 1400 has a smaller inner diameter than the inner diameter of the bore sleeve 1340. Control body 1170 has a smaller diameter than plunger 1300 that can reinforce stop 1400. Plunger 1300 is restricted from moving towards the spool valve 1190 beyond stop 1400. Stop 1400 can be a washer or cylindrical member that is inserted in the bore 1180 prior to insertion of the plunger 1200. Stop 1400 restricts movement of the plunger 1200 in the bore 1180 in the direction of spool valve 1190. Plunger 1200 is fittable in the bore sleeve 1340 and the stop 1400 has a smaller inner diameter than the bore sleeve.

A second mechanical stop 1410 is incorporated into the plunger assembly 1330. Plunger 1200 has a variable diameter. A smaller shaft of the plunger acts as a mechanical stop 1410 and is fitted with spring 1320. The smaller shaft or stop 1410 restricts movement of the plunger 1200 toward the bore sleeve 1340. In the shown embodiment, stop 1410 is designed to interface with the bore sleeve 1340 when spring 1320 bottoms out.

Referring now to FIG. 7, there is shown therein the regulator valve assembly 1150 of FIG. 6 in the second stage. A signal pressure is received by the regulator valve assembly 1150 and the clutch assembly 1160 is filling and stroking. In this arrangement, the downstream pressure experienced in chamber 1370 is less than the feedback pressure experienced in channel 1290. Plunger 1200 is moved toward the bore sleeve and away from mechanical stop 1400. Spring 1320 is compressed as well as spring 1210. Stop 1410 is engaged with the bore sleeve 1340 to a predetermined length. In one embodiment, the predetermined length is the flow gain feature length. Fluid exits chamber 1370 through an orifice 1360 in the bore sleeve 1340. Spool valve 1190 is moved farther leftward as well. The flow area in the regulator valve 1150 is increased in the second stage. More fluid is received at a greater rate than when operating in the first stage. The flow capability of the regulator valve assembly 1150 is increased, not only by the movement of the spool valve 1190 with respect to the plunger 1200 but also by the movement of the dual-stage plunger assembly 1330 with respect to the control valve body 1170.

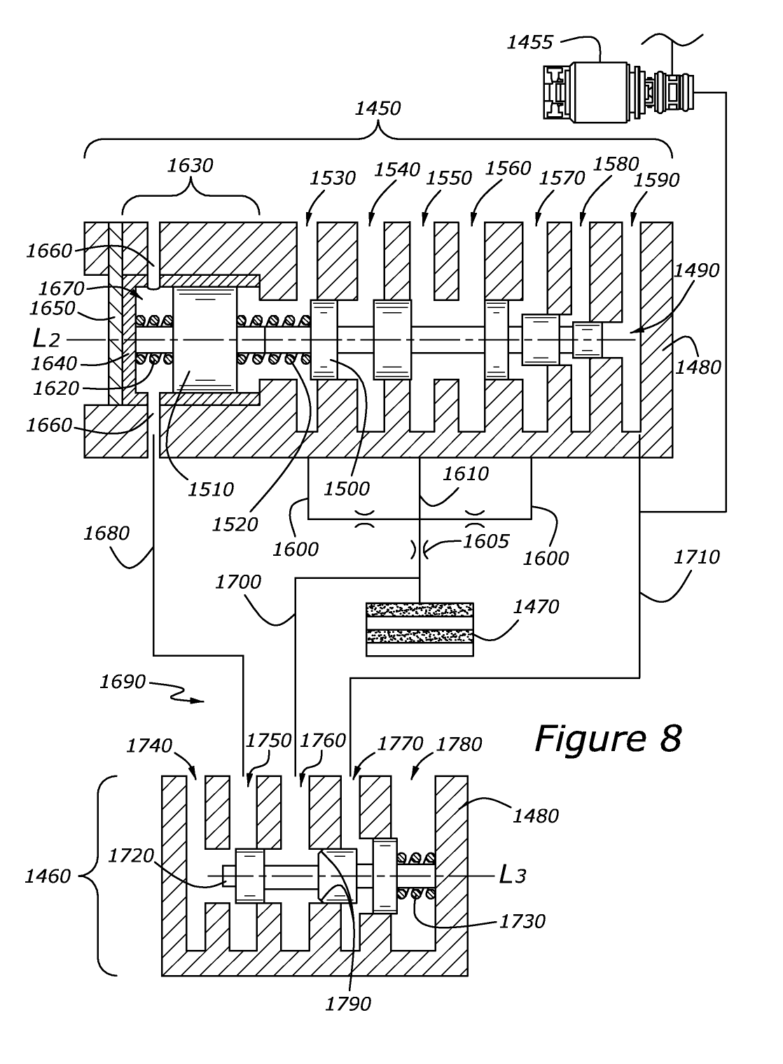

FIG. 8 illustrates another exemplary embodiment of a dual-stage regulator valve assembly 1450. Regulator valve 1450 is connected to a latch valve 1460 that receives a downstream of fluid from the regulator valve 1450 when operating in the second stage and supplies the downstream fluid to the clutch 1470. In this arrangement, in addition to sensing flow across the flow control orifice, the second stage of regulator valve assembly 1450 can be achieved through exhausting channel 1680 and port 1670 through control of latch valve 1460 by the electro-hydraulic solenoid command. Additionally, the feedback pressure is not exhausted from the regulator valve assembly 1450.

In FIG. 8, the regulator valve 1450 is shown in a second stage. In this stage a predetermined solenoid 1455 signal pressure has been received at the regulator valve 1450 and the clutch 1470 is being applied. The regulator valve 1450 is included in a control valve body 1480. A bore 1490 is formed in the control valve body 1480. A spool valve 1500 is nested in a control valve bore 1490 (or pressure chamber) in the control body 1480. Spool valve 1500 is biased (or sprung) with respect to a plunger 1510. A coil spring 1520 is positioned between the plunger 1510 and the spool valve 1500. Spool valve 1500 is configured to move along a longitudinal axis L₂. Spool valve 1500 has a variable diameter along the longitudinal axis L₂ of spool valve. The portions of the spool valve 1500 having a smaller diameter act in concert with ports (e.g., 1530-1590) in control body to govern the distribution of fluid through control body 1480.

The spool valve 1500 of FIG. 8 can achieve various positions to regulate flow distribution to the clutch assembly 1470; spool valve 1500 is of a similar configuration to the spool valve 1190 discussed with respect to FIG. 6. Port 1590, as shown in FIG. 8, is in fluid communication with an electro-hydraulic solenoid 1455 that selectively provides a pressure increase to the regulator valve assembly 1450. Ports 1530, 1550 and 1570 are in fluid communication with the transmission clutch assembly 1470 through channels 1600 and 1610, and provide fluid to the clutch assembly. Chamber 1670 is in fluid communication with a latch valve assembly 1460 (as is discussed below).

In the illustrated embodiment of FIG. 8, spool valve 1500 is shown in a second position. In the second position regulator valve assembly 1450 is fully open, allowing fluid communication from port 1550 to port 1560 through control valve bore 1490. Ports 1540 and 1580 are exhausts and are open to sump. Ports 1530 and 1570 provide a feedback pressure to the regulator valve.

In the second position as shown in FIG. 8, the spool valve 1500 is moved leftward and spring 1620 is compressed. A dual-stage plunger assembly 1630 is also provided in the embodiment shown in FIG. 8. The plunger assembly 1630 includes a plunger 1510 that is biased with respect to the control valve body 1480. Plunger assembly 1630 is nested in a bore sleeve 1640. The sleeve 1640 is positioned between spring 1620 and a retainer plate 1650 in the control valve body 1480. Control body 1480 has a smaller diameter than plunger 1510 at the land left of port 1530 that can also act as a stop for plunger. In the shown embodiment, the bore sleeve 1640 includes an orifice 1660 through which fluid can enter/exit chamber 1670 through channel 1680. Spring 1620 enables plunger 1510 to move along longitudinal axis L₂. Spring 1620 is at a sufficiently higher load than spring 1520 so that the plunger 1510 is biased rightward when the pressure difference between sides of plunger 1510 is below a predetermined value.

As also shown in FIG. 8, the control valve body includes a control pressure circuit 1690. Control pressure circuit 1690 includes the latch valve 1460 and various channels 1680, 1700 and 1710 interconnecting the regulator valve assembly 1450, latch valve 1460 and transmission clutch assembly 1470.

With respect to FIG. 8, downstream fluid is channeled to the latch assembly 1460 from chamber 1550 through channels 1610, 1700. The latch valve 1460 is also in fluid communication with the regulator valve assembly 1450 through channels 1680 and 1710. Channel 1710 is in direct fluid communication with port 1590 which receives the signal pressure from an electro-hydraulic solenoid. Channel 1700 is connected to another channel 1610 that extends between the regulator valve 1450 and the transmission clutch 1470 downstream of flow control orifice. A flow control orifice 1605 is provided. When the pressure signal is received in the regulator valve 1450, this pressure is also experienced in the latch valve 1460. Latch valve 1460 is included in a remote location on the control valve body 1480. Latch valve 1460 includes a spool valve 1720. The spool valve 1720 is configured to move along a longitudinal axis L₃. A spring 1730 is included in the latch valve 1460. Spool valve 1720 is biased with respect to a wall of the control valve body 1480.

Spool valve 1720 has a variable diameter along the longitudinal axis L₃ of spool valve. The portions of the spool valve 1720 having a smaller diameter act in concert with ports (e.g., 1740, 1750, 1760, 1770 and 1780) in control body 1480 to govern the distribution of fluid through control body. Spool valve 1720 includes a chamfered edge 1790 or ramp.

Latch valve assembly 1460 is configured to break communication between supply and output circuits of latch valve, at ports 1760 and 1750 respectively where that circuit contains the pressure downstream of flow control orifice as described above for FIGS. 6 and 7. When spool valve 1720 is in the “stroked” position, channel 1700—which is fed into port 1760—will be disconnected from port 1750 and channel 1680. Channel 1680 is no longer in fluid communication with port 1670 and plunger 1510. The pressure differential seen across plunger 1510 causes plunger to move rightward until plunger stems contact sleeve 1640, resulting in the second stage configuration as described above.

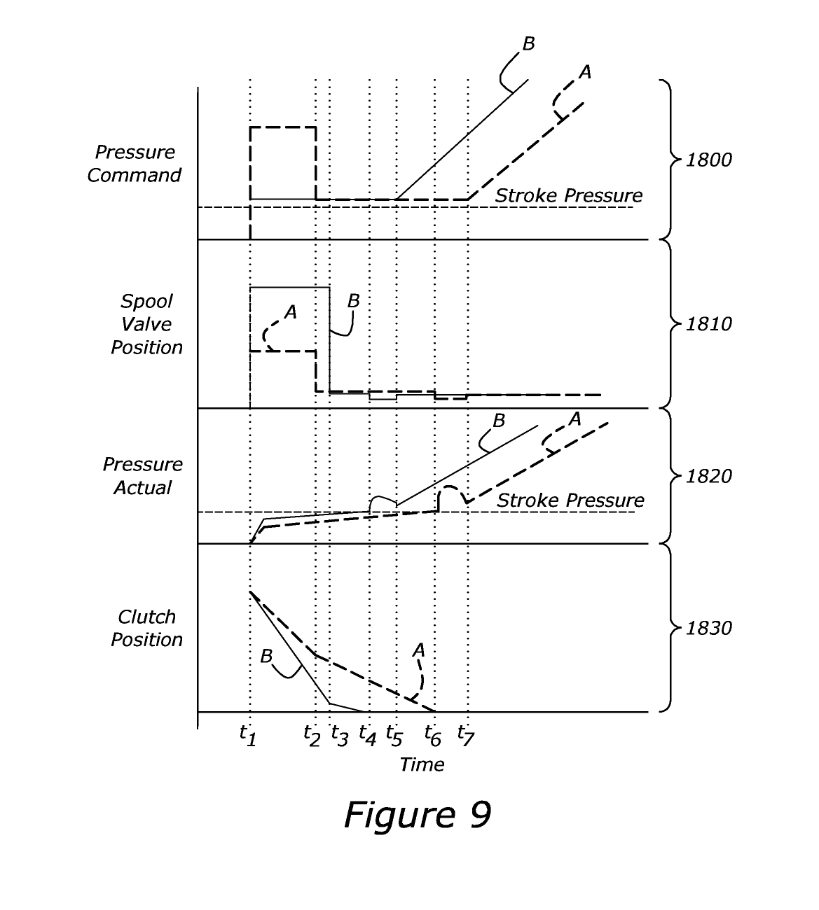

Turning now to FIG. 9, there are shown prior performance diagrams and projected performance diagrams for a dual-stage regulator valve assembly according to an exemplary embodiment of the present invention. FIG. 9 shows a graph 1800 of pressure commands received from the electro-hydraulic solenoid over time. Line A represents the pressure command required of a conventional regulator valve assembly. An initial pressure command (at t₁) is sent to the regulator valve. The pressure command is substantially greater than the stroke pressure (pressure at which clutch plates are touching or “stroked”). What is commonly referred to as a “boost command” is sent to the regulator valve. This calibrated pressure command is used to stroke the clutch in less time. The magnitude and duration (t₂−t₁) of boost command is determined empirically. Commanded pressure must be reduced before completion of clutch stroke to avoid increased pressure overshoot. Boost duration is limited due to part to part variability. The boost command is not required for the dual-stage regulator valve, eliminating need to map and calibrate time and pressures for all conditions. In Line B the pressure command escalades at t₅ as compared to a later time of t₇ in conventional designs, as shown in Line A.

FIG. 9 shows a graph 1810, the positions of a spool valve in a regulator valve assembly over time. In conventional regulator valve assemblies, valve position is determined by the pressure error on the spool valve and the rate of spring in the regulator valve assembly. Line A illustrates valve displacement corresponding to boost command referenced above. The dual-stage regulator valve assembly, as represented by Line B, enables the spool valve to achieve greater displacement, and this displacement can be maintained for a longer period (t₃−t₁) because it is automatically controlled based on flow induced pressure differential across plunger in dual stage plunger assembly. This enables the regulator valve to fill clutch in less time. At time t₃ the dual-stage regulator assembly returns to a metering position with smaller flow area than conventional configurations due to flow gain control feature.

FIG. 9 shows a graph 1820 of the actual pressure in the clutch assembly as a function of time. As shown, a conventional regulator valve (Line A) achieves the desired stroke pressure and applies the clutch at t₆. The dual-stage regulator valve assembly reaches the stroke pressure significantly sooner than conventional designs (at t₄) due to larger flow area. Regulator valve assemblies experience a pressure spike due to the change in compliance when the clutch completes stroke. This pressure spike is a function of the circuit compliance, valve position, valve speed and flow gain. The dual-stage regulation valve which when in first stage can be set to lower flow gain and smaller valve position can significantly reduce pressure spike.

With reference to FIG. 9, there is shown a graph 1830 of the clutch position of a conventional and dual-stage regulator valve assembly as a function of time. Notice the shorter stroke time required for the dual-stage regulator valve assembly, shown in Line B, due to the larger valve opening and greater displacement of the spool valve due to second stage operation. Also note reduce rate of change in Line B, at time t₃ when in first stage. Line A represents a conventional regulator valve assembly.

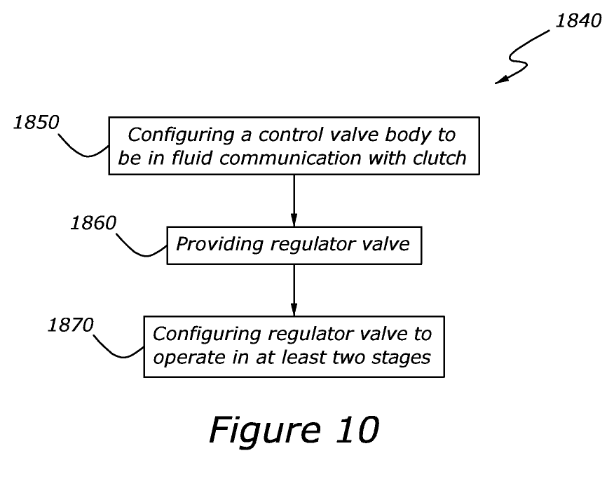

A method 1840 of manufacturing a hydraulic control valve body for controlling a transmission clutch is shown in FIG. 10. The method includes: configuring a control valve body to be in fluid communication with the transmission clutch 1850; providing a regulator valve in the control valve body configured to direct fluid to the transmission clutch 1860; and configuring the regulator valve to operate in two stages 1870. A flow area in the regulator valve is greater when the regulator valve is operating in a second stage than when operating in a first stage. Fluid communication can be achieved between the various components though, e.g., formed channels in the control body.

In one embodiment, the method also includes: providing a dual-stage plunger assembly for the regulator valve. The dual-stage plunger assembly enables the regulator valve to operate in two stages. The assembly includes a plunger spring biased with respect to the control valve body; and a spool valve spring biased with respect to the plunger, for example as discussed with respect to FIGS. 2 and 3. The method includes forming a flow control orifice in the control valve body at the regulator valve; the flow control orifice is in fluid communication with one end of the plunger. In another embodiment, a bore sleeve is provided between the plunger and the control valve body, the bore sleeve defining a chamber at one end of the plunger, for example as shown in FIGS. 5-8. The method also includes forming an orifice in the bore sleeve configured to be in fluid communication with the flow control orifice.

In yet another embodiment, the method includes forming features in the control body to control the flow capability of the regulator valve. The method, for example, includes: forming at least one of a notch or ramp in the control valve body; and configuring the notch or ramp to be in fluid communication with the regulator valve.

In another embodiment, the method of manufacturing the control valve body includes providing a latch valve configured to receive a fluid from the regulator valve downstream of flow control orifice. When the regulator valve is operating in the first stage the latch valve can be configured to provide the downstream fluid to the dual-stage plunger. When the regulator valve is operating in the second stage the latch valve can be configured to remove the downstream fluid to the dual-stage plunger.

The control valve bodies disclosed here can be manufactured using existing forming techniques, e.g., casting, milling, or lathing. Most commonly, control valve bodies are composed of an aluminum alloy and die casted. Regulator valve assemblies are inserted into bores formed in the control valve bodies. Spool valves can be formed of any number of materials including metals, hard plastics and alloys.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description or claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “a plunger assembly” includes two or more different plunger assemblies. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the methodologies of the present disclosure without departing from the scope of its teachings. Other embodiments of the invention will be apparent to those skilled in the art from consideration of the specification and practice of the teachings disclosed herein. It is intended that the specification and examples be considered as exemplary only.

While the best modes for carrying out the invention have been described in detail, those familiar with the art to which this invention relates will recognize various alternative designs and embodiments for practicing the invention within the scope of the appended claims.

We claim:

1. A hydraulic control circuit for controlling a transmission clutch, comprising:
a control valve body configured to be in fluid communication with the transmission clutch; and
a regulator valve in the control valve body configured to direct fluid to the transmission clutch, the regulator valve including:
a dual-stage plunger assembly;
wherein a flow area in the regulator valve is greater when the dual-stage plunger assembly is operating in a second stage than when operating in a first stage.

2. The control valve body of claim 1, wherein the dual-stage plunger assembly comprises:
a plunger spring biased with respect to the control valve body; and
a spool valve spring biased with respect to the plunger.

3. The control valve body of claim 2, further comprising:
a flow control orifice formed in the control valve body between the regulator valve and the transmission clutch, the flow control orifice configured to be in fluid communication with one end of the dual-stage plunger assembly.

4. The control valve body of claim 2, further comprising:
a bore sleeve between the dual-stage plunger assembly and the control valve body, the bore sleeve defining a chamber at one end of the plunger; and
an orifice in the bore sleeve configured to be in fluid communication with the flow control orifice.

5. The control valve body of claim 1, further comprising:
a latch valve configured to receive a downstream of fluid from the regulator valve when the dual-stage plunger assembly is operating in the second stage.

6. The control valve body of claim 1, further comprising:
a notch in the control valve body configured to be in fluid communication with the regulator valve.

7. A control valve body for controlling a transmission clutch, comprising:
a spool valve configured to move within a bore in the body;
a dual-stage plunger assembly at one end of the bore, the plunger assembly including:
a plunger;
a first spring between the spool valve and plunger; and
a second spring between the plunger and the control valve body;
wherein when the assembly is in a first stage the plunger is in a first position;
wherein when the assembly is in a second stage the second spring compresses and the plunger moves into a second position;
wherein a flow area across the spool valve is greater when the plunger is in the second position;
wherein the dual-stage plunger assembly is configured to automatically transition between the first stage and the second stage when the transmission clutch approaches an end of fill;
a flow control orifice in the control valve body at the bore;
a first channel extending between the flow control orifice and the clutch; and
a second channel extending between the dual stage plunger assembly and the first channel;
wherein the second channel is configured to decrease pressure at one end of the plunger assembly during clutch fill thereby enabling the plunger assembly to operate in the second stage.

8. The control valve body of claim 7, wherein the plunger is a spool valve.

9. The control valve body of claim 8, further comprising:
a retainer plate between a first end of the plunger and second end of the plunger, wherein the retainer plate is configured to restrict movement of the plunger in at least one direction.

10. The control valve body of claim 7, wherein the spool valve comprises a chamfered edge.

11. The control valve body of claim 7, further comprising:
a mechanical stop configured to restrict movement of the plunger in the bore.

12. The control valve body of claim 11, wherein the mechanical stop includes a flange in a bore sleeve, the plunger fittable in the bore sleeve and the flange having a smaller inner diameter than the inner diameter of the bore sleeve.

13. The control valve body of claim 7, further comprising:
a notch in the control valve body.

14. A control valve body for controlling a transmission clutch, comprising:
a regulator valve configured to direct the fluid to the transmission clutch; and
a control pressure circuit in fluid communication with the regulator valve, the control pressure circuit including:
a latch valve; and
a channel extending between the regulator valve and the latch valve;
wherein the regulator valve has a first stage and second stage of operation and the flow area in the regulator valve is greater when the regulator valve is operating in the second stage than when operating in the first stage;
wherein the control pressure circuit is configured to decrease pressure at one end of the regulator valve during clutch fill thereby enabling the assembly to operate in the second stage;
wherein the regulator valve is configured to automatically transition between the first stage and the second stage when the transmission clutch approaches an end of fill.

15. The control valve body of claim 14, further comprising:
a bore sleeve at one end of the regulator valve comprising an orifice in fluid communication with the channel.

16. The control valve body of claim 15, wherein the latch valve is configured to receive a downstream of fluid from the regulator valve.

17. The control valve body of claim 16, wherein the latch valve is configured to exhaust the downstream fluid from one portion of regulator valve to another portion of the regulator valve.

18. The control valve body of claim 14, wherein the latch valve comprises a spool valve sprung with respect to the control valve body.

19. The control valve body of claim 18, wherein the spool valve comprises a chamfered edge that abuts the channel.

20. The control valve body of claim 14, wherein the regulator valve assembly includes:
a plunger spring biased with respect to the control valve body; and
a spool valve spring biased with respect to the plunger;
wherein at least one end of the plunger is in fluid communication with the latch valve, the latch valve configured to reduce pressure at the end of the plunger when the regulator valve is operating in the second stage.
